(19) United States
(12) Patent Application Publication
(10) Pub. No.: US 2020/0407604 A1
(43) Pub. Date: Dec. 31, 2020

(54) BIOFIBER FILM

(71) Applicant: Biofilmax, Lansing, MI (US)

(72) Inventor: Earnest Dwice Stuart, Lansing, MI (US)

(73) Assignee: Biofilmax, Lansing, MI (US)

(21) Appl. No.: 16/975,537

(22) PCT Filed: Feb. 26, 2019
(86) PCT No.: PCT/US19/19614

§ 371 Date: Aug. 25, 2020

Related U.S. Application Data
(60) Provisional application No. 62/635,152, filed on Feb. 26, 2018.

(51) Int. Cl. C09J 11/08; C09J 5/06; C09J 177/00; C08J 5/12; B32B 7/12; B32B 27/08; B32B 27/32; B32B 37/00; B32B 37/12

(52) U.S. Cl. CPC C09J 11/08; B32B 2439/46; C09J 177/00; C08J 5/128; B32B 7/12; B32B 27/08; B32B 27/32; B32B 37/0053; B32B 37/12; C09J 2401/00; C09J 2477/00; C09J 2467/008; C08J 2367/02; C08J 2477/00; C08J 2401/02; B32B 2255/10; B32B 2255/205; C09J 5/06

(57) ABSTRACT

A thin film laminate having high percentages of biomass microparticles, and methods of making the same involve mixing biomass-microfibers with an adhesive, wherein the mixture comprises at least 50% biomass-microfibers by weight, heating the mixture above the melt temperature of the adhesive, and disposing the heated mixture between plastic sheets.

### CROSS-REFERENCE TO RELATED APPLICATIONS

This application claims priority to PCT Application No. PCT/US2019/019614, filed Feb. 26, 2019 and which claims benefit of U.S. Provisional Application No. 62/635,152, filed Feb. 26, 2018, of which are incorporated herein by reference in their entireties.

### FIELD OF THE DISCLOSURE

This disclosure relates to the formulation of thin film biomass and plastic production methods, and products containing high percentages of native biomass, bound by low concentrations of adhesives. More specifically, it relates to a biomass-adhesive laminate which also acts as an adhesive to attach other laminates.

### BACKGROUND

Snack bags, approximately 2 mil (51 μm) thick are typically hydrocarbon-based polypropylene. One notable exception is PepsiCo-FritoLay's 2010 release of SunChips™ made of 100% NatureWorks Ingeo™ bio-degradable biopolymer resin polylactic acid (PLA). These bio-based resins for thin film snack bags are more expensive than hydrocarbon-based resins. The cost of PLA is driven by producing lactic acid through fermentation of sugar or starch and in converting lactic acid into a monomer, which is then polymerized to form PLA.

Smooth surface thin film containing well-dispersed microfiber-biomass at 40% weight-to-product, with 99% of the microfibers being less than 10 μm, with a 5-6 μm average particle size in 1-2 mil snack bag film was first achieved in prior art using, respectively, polylactic acid, polypropylene and high-density polyethylene combined with bipolar copolymer compatibilizers and other additives in compounding and blown film at 150° C.−200° C. (Stuart). Elevated temperatures drive decomposition reactions increasing odors from hemicellulose carbohydrates, starch and protein with odors stronger than unheated native biomass odors. Even pleasant odor is unacceptable in snack food packaging.

Practical methods for direct use of biomass in thin film at more than 40% may lower snack bag costs and could be disruptive to snack food and other food packaging markets. Additionally, the need for hydrocarbon-competitive bio-degradable plastic products is persistent.

### SUMMARY OF THE DISCLOSURE

Disclosed is a method for building a laminate consisting principally of a high percentage of biomass microfibers, a smaller percentage of adhesive relative to the microfibers, optional fillers such as CaCO3, and compatibilizers. The method increases the percentage of biomass in thin film products beyond prior art while reducing or eliminating percentages of more expensive inputs such as resin, compatibilizers, bonding and flex agents, dispersant agents etc.

In one aspect, the method reduces costs associated with conventional blown films used in snack bags and other food packaging, and many other packaging solutions. The method builds a core biomass-microfiber/adhesive laminate or laminates which may also be produced within a multi-laminate composite consisting of the core biomass-microfiber/adhesive laminate(s), also referenced herein as an “adhesive laminate” layered on one or each side with blown or cast thin film plastic laminates made with plastic resins such as PET, BOPP, HDPE, polypropylene, PLA, as examples, glued to one or each side of the adhesive laminate using the adhesive on the adhesive laminate's surface while at the adhesive's molten temperature, under compression, with additional optional adhesives applied.

In an aspect of building the adhesive laminate, the biomass microfibers and adhesives is pre-mixed with biomass microfibers highly compressed, heated to adhesive molten temperature and squeezed onto compressive rollers, belts or other compression devices known to those skilled in the art. Whether producing an adhesive laminate or an adhesive laminate combined with pre-blown plastic film into a composite laminate, heat is applied to bring the adhesive to its molten state to melt adhesives intimately with and biomass microfibers which are then subjected to compressive mechanical forces of any suitable type to intimately further melt adhesive around and intimately into the surface fissures of the biomass, for adding mechanical strength and for further compressing biomass microparticles together, which tend to have some flexibility, to eliminate space between particles, increasing biomass microfiber percentages while achieving high levels of bonding between compressed biomass particles. Further, compression under heat shapes the adhesive laminate and the composite laminate containing pre-blown film laminates. Optional CaCO3 fillers, strengthening and flex compatibilizers and other fillers can be used in combinations depending on end-product specifications which can range widely in thickness and strength.

The disclosed laminate replaces more expensive plastics, compatibilizers, and adhesives used in compounding and blown film processes, and largely replaces the need for extrusion and blown film while also greatly reducing percentages of more expensive components within the present inventive formula except for the outer blown thin film laminates described herein. Outer plastic laminates may be thinner than conventional outer layers due to support from the adhesive laminate construction, including addition of optional CaCO3. Operating temperatures are lower in this disclosure than in conventional film manufacturing due to lower optional melting point of candidate adhesives which greatly reduces odors generated by heated biomass. Wet type of adhesives may be utilized in place of melt adhesives, wherein the mixture is flash dried as the adhesive laminate is compressed to its final dimension.

In a further aspect of this disclosure, one layer of vapor-deposited aluminum is typically applied upon plastic film laminates for most food packaging as a moisture vapor barrier to keep snacks crispy. Vapor deposited aluminum or other metals can optionally be applied to more than one laminate within the composite laminate, one on the inside of the print film and one on the inside of the composite laminate which becomes the inside of the bag to insure blocking any biomass odor or moisture vapors from reaching crispy snacks or other foods on the inside of snack bags, as well as preventing the biomass derived odors from being detectable on the outside of snack bags or any other use in food packaging covering.

Conventional high temperature extruded blown thin-film plastic research methods targeting addition of biomass to plastic have at best smoothly dispersed biomass within resins, leaving gaps between particles which necessarily contain high amounts of very expensive strength, flex, stretch and bonding compatibilizers which do not always adhere well to the relatively smooth surfaces of biomass microfibers at below 16 μm top particle size.

In a still further aspect of this disclosure, the biomass-adhesive laminate or laminates described herein function as a structural element, but also as glue/adhesive for attaching outer laminates or optionally inner laminates to create a composite multi-layer laminate, which can be done simultaneously during production of the adhesive laminate; alternately, the biomass-based adhesive laminate can be produced complete on its own, then delivered from a roll to be rolled and laid together with pre-blown plastic laminates under heat and pressure onto large rolls.

Shifting from plastic to biomass is an important technical and economic step towards cost-effective 100% bio-based, and ultimately lower-cost bio-degradable thin film products.

In one more aspect of this disclosure, bio-based adhesives are used including protein-based adhesives. Many bio-based adhesives have proved to be suitable for use in food packaging snack bags. The use of adhesives such as 3M Super77, Gorilla Glue, JBWeld and other adhesive glues have been used to glue biomass microparticles together, and the microparticles to sheets of thin plastic laminates, wherein all these adhesives worked to varying positive degrees with different setups, different temperatures and times. However, the drawback of using many such adhesives is that they are not acceptable for food packaging due to VOCs and other factors. Hence, the search continues for an ideal food packaging appropriate adhesive.

### BRIEF DESCRIPTION OF THE DRAWINGS

FIGS. 1A and 1B illustrate a comparison of compounded resin with compressed adhesive densities (FIG. 1B) against conventional thin film components (FIG. 1A).

FIG. 2 illustrates the thin film components and structure contemplated for one embodiment.

FIG. 3 illustrates the thin film components and structure contemplated for another embodiment.

FIG. 4 illustrates a method of assembly of the components as exemplified by one of the embodiments.

FIG. 5 illustrates a method of assembly of the components as exemplified by another embodiment.

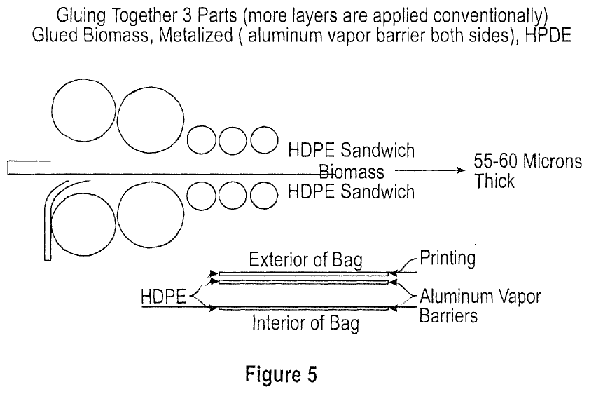

### DETAILED DESCRIPTION

A method for fabricating a multi-lamina composite consisting of blown or cast-film bonded to each side of a thicker biomass-based core is disclosed. The method increases the percentage of biomass in thin film products beyond prior art while reducing or eliminating percentages of more expensive materials such as compounded resin blown film. The distances and volume of “space” between well-dispersed biomass-microparticles in resin-based compounding results in minimal direct contact between biomass microparticles. In a 40% biomass-based plastic, resins and additives can be effectively used as “fillers” between bio-microfibers beyond their primary practical effective purpose of particle-to-resin adhesion.

### Multi-Part Bio-Based Laminate

The method for production of multi-lamina composites can include hammermilling biomass, supplying an extremely thin layer or layers of adhesives by rolling or other means, and/or milling adhesives, and optionally milling other additives to fine particle size to match the size of biomass microfibers. Other steps can include air classification of biomass, mixing biomass with adhesives, heating the mixture of biomass microfiber and adhesive, optionally with other additives, spreading the mixture onto a roller/moving belt or the like, or rolling any or all of the above, compression rolling of a single laminate, and cooling and hardening of the laminate.

Hammermills or other grinding systems containing a 0.5 mm hole size hammermill screen such as those manufactured by Prater, are used to grind whole oat hulls from oat processors such as Quaker or General Mills to achieve an average particle size of 250 μm; adhesives, and optional additives such as CaCO3, strength compatibilizers, coloring agents may be ground in the same way as described above for oat hulls. Further, any type of biomass can be processed for use in the disclosed processes and laminates.

Hammermilled oat hulls, or unground oat hulls are milled into smaller microfibers with one top particle size of −16 μm, or −10 μm to produce a final thin film product such as “crispy snack” bags approximately 2 mil consisting of laminates glued together, each laminate having unique functions and dimensions within the final laminate product. Films consisting of greater than 2 mil thickness can be created with larger dimension biomass microfibers. Within the scope of this disclosure, top particle size is determined by the final film dimension where the preferred particle size is at or less than 20% of the final production dimension, while the function of high percentages of biomass and lower percentages of adhesive applies in all formula of this disclosure. The primary target for the disclosed product is 1-4 mil thickness.

In one embodiment, milling of biomass is performed in an attrition mill such as a Union Process attritor, or a combo attrition mill/classifier as manufactured by RSG, or a ball mill or similar mill manufactured by RSG and many other companies, or a rod mill as manufactured by Micro Grinding Systems, for up to 12 hours, or longer, using, in one embodiment, a preferred size ball media of ¼″, or ¼″ combined with smaller sized media; e.g. 1/16″ as an example; or rods in a rod mill of ¼″, or smaller, or larger: media changes can include tungsten steel for a denser, heavy media which lasts longer than the most metal media, and grinds faster than stainless steel due to density, for example; higher and smaller sized end product will determine the choice of media and residence.

Biomass microfiber separation is done using an air classifier to dis-agglomerate the agglomerates created in milling to extract −16 μm, or −10 μm and smaller top particle dimension size, with an average top dimension particle size of 4-6 μm or for larger top particle size oat hull microfibers for larger dimension film up to 4 mil.

First pass in the dis-agglomeration step on finely milled oat hulls typically shows a profile containing approximately 30-40% −10 μm particles of the feed to a top particle size of 16 μm, or with additional passes through the classifier, and preferably, −10 μm for use in 2 mil plastic laminates. The smaller microfibers extracted are herein called “FINES”; biomass microfibers separated away from FINES, consisting of microfibers greater in size than 16 μmare hereinafter referred to as “OVERS”. Overs in the first or second pass represent approximately 70% of pre-milled inflow biomass and are further ground as described above using an attritor, rod or ball mills, attritor mills combined with continuous air classification. FINES from all classification are combined with other Fines at −16 or −10 μm and OVERS combined with OVERS from other steps for further milling, dis-agglomeration and classification; additional fine grinding as described herein until at least 50%, 70%, 80%, 90% or 100% of original intake oat hulls have reached a target top particle size of −16 or −10 μm. The biomass-microfibers can have a maximum dimension less than 20 μm, less than 15 μm or less than 10 μm.

The biomass microfiber <16 μm or <10 μm FINES is mixed with pre-ground adhesive(s) such as 100 μm average particle size, or as small as <16 μm, or adhesive much larger but applied in any other form as a melt adhesive, a wet/fast drying adhesive, a binary adhesive, or any adhesive known to those skilled in the art, and optionally adding CaCO3, compatibilizers, and any other additives to improve adhesion, strength and flexibility; an example being 70% oat hull microfibers, 15% adhesives such as Arkema Platamid, or protein-based adhesive particles, optionally 15% CaCO3, results in an effective adhesion between particles, and adhesion between the biomass-based adhesive laminate, wherein the adhesive is molten, adheres to pre-made/blown or cast plastic laminates rolled, compressed or dried onto the outside of the composite laminate. Thicker strips of adhesives can be laid parallel to the flow of the laminate build over rollers, which are spread to small dimension thickness, on and in between described oat hull and other biomass microfibers to create internal and surface adhesive properties for the laminate. Spot application of adhesive in molten form can be utilized with molten adhesive.

In other embodiments; adhesives, CaCO3, and other additives (e.g., compatibilizers) are ground using similar methodology as described herein to similar top particle size, generally FINES, at or below 16 μm. Further, cryogenic or refrigeration cooling may be employed to ensure the ground substrate is well below glass transition temperature for effective grinding. The mixture, either with or without calcium carbonate and/or additives, preferably comprise at least 50%, more preferably 60%, 80% or 90% biomass-microfibers by weight. Adhesives FINES may be larger than 14 μm, as they have been found to melt sufficiently to compress, combine, spread and adhere with biomass and adjacent plastic thin film sheets under compressive energy and adhesive melt temperatures described below. One particle size option of adhesive FINES is ˜16 μm. but average of 100 microns has been shown to work well for bind oat hull particles and to bind biomass-adhesive formula to plastic laminates added during heat and compression; high particle size adhesives can be practical, while not necessarily being optimal. The ratios of the components may vary depending on the thickness of final product, type of biomass and final construct specifications of the laminate.

Heating the low moisture biomass microfiber/adhesive/CaCO3 FINES mixture described above in any system known to persons skilled in the art at or above the melting point of a select adhesive, is pushed forward with a suitable mechanical device such as an internal metering screw with associated weight-loss measurement device to insure precision delivery of target flow rate of dry material mixture, while continuing to be pushed forward.

The heated mixture containing molten adhesive is metered and spread onto a roller or moving belt or other such compression device known to those skilled in the art; the mixture is evenly spread close to the final width of the complete laminated sheet.

The compression system rolls out the pre-measured mixture between rollers, or belts and rollers or other compression device for shaping and sizing to facilitate spreading a layer of the oat hull/adhesive/CaCO3 mixture at a prescribed thickness of 10-25 microns thick when targeting a final film laminate approximately 2 mil thick; In one embodiment, a single laminate consisting of oat hull microfibers, adhesive, optionally CaCO3 and other optional additives are compressed into a single laminate/adhesive.

In another embodiment, for the production of a MULTI-LAYER LAMINATE; oat hull/adhesive, CaCO3 and additives are fed onto a roller while pre-blown or cast plastic thin film laminates are fed parallel to the adhesive laminate which are glued to the adhesive laminate under heat and pressure, onto a roller, rollers or roller-belt or other compression system to form a multi-layer laminate, on one or two sides or on top and bottom of the biomass mixture in intimate contact with molten adhesive-biomass microfibers, continuing through the compression step to further shape and size the thickness of the composite laminate.

The single laminate oat hull/adhesive or the multi-laminate is cooled and cured by reducing the temperature below the prescribed adhesive molten point rapidly to ambient temperature, in the case of a multi-laminate, all laminates are glued together and are rolled up as a final product.

A combination of laminate layers is completed to mirror traditional plastic films used in snack food and other crispy food packaging. Print film sheets, vapor deposited aluminum vapor barrier or barriers, and final plastic sheets over bag interior vapor barriers, which can all be laminated using the biomass-based adhesive laminate as the glue on some or all adhesives required in laminating. Two feeds of blown-thin film sheets each from 1-20 μm, preferably from 1-12 μm thick, each consisting of any one of BOPET, polypropylene, high density polyethylene, Green Dot™ bio-resins, NatureWorks™ polylactic acid and any other bio-resins are fed continuously onto large opposing rollers through prescribed size gaps.

The combinations of any and all of the above embodiments are employed to optimize the effectiveness of the core process embodied in the various examples described herein.

In another embodiment, multiple types of bonding agents can be deployed together, separately and/or in various time points in sequence to achieve a first, fast or instant bonding, e.g. a “superglue” type of glue, followed by another, longer curing but strong glue for additional strength when fully cured, and optionally for added flexibility or stiffness. A bio-based, preferably protein-based, or a protein/carbohydrate-based adhesive is preferred and establishes a platform for a complete and cost-effective biobased and biodegradeable film product. Water-based, melt-adhesive or any adhesive suitable for food packaging may be employed within the disclosed laminates.

In one alternative embodiment, any additional adhesive formula may be applied to either one or two of the fed plastic thin film sheets as described herein in small particle, mist form, precisely measured for final pressurized distribution throughout the biomass-microparticles during next-step compression.

Alternatively in other embodiments, the same types of adhesives are applied in their liquid form in near simultaneous precision timing relative to compression. Water-based adhesive can be applied followed by a fast moisture removal step.

Immediately in front of rollers, metered biomass-microfiber and pre-applied adhesives, or microfibers and simultaneously applied adhesives, or pre-mixed biomass-adhesive-optional additives, immediately before the moving casings reach the compression roller, and other additives, or vapor deposited adhesives, or mist micro-drops, are instantly compressed by the compression roller and the fixed position roller, up to levels at which no reduction in volume can be achieved mechanically, or optionally to a pressure point and thickness less than described above to accommodate microflow of adhesives, additives and optionally hot resin melt through micro interstices within compressed particles. The greatest compression of the laminates is with the biomass microparticles; which is especially true when a wet adhesive has been applied and is being flash dried.

Thickness of the final laminate is product dependent and the inventive methods applied herein are not limited by specific product thickness or specific formulation, as compressive systems and biomass-microfiber/adhesive/additive formula are adjustable within the disclosed method.

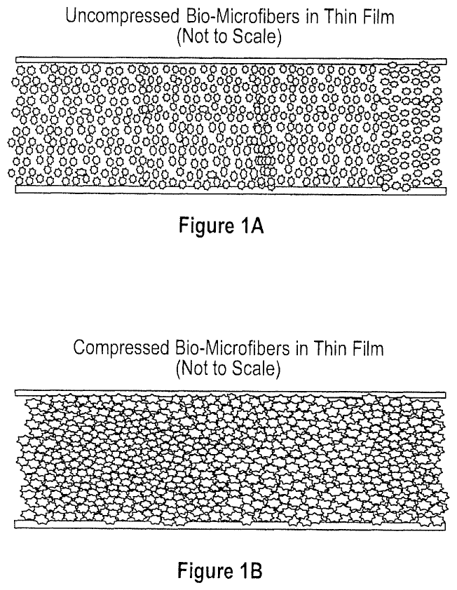

FIG. 1 illustrates a comparison between conventional thin film components (FIG. 1A) and the components disclosed herein. FIG. 1B illustrates a biomass adhesive mixture along with plastic laminates on each side of the mixture in accordance with this disclosure. The figure further illustrates that the spaces between the particles has been reduced by crushing biomass microparticles together and reduces the need for expensive adhesives at the same time.

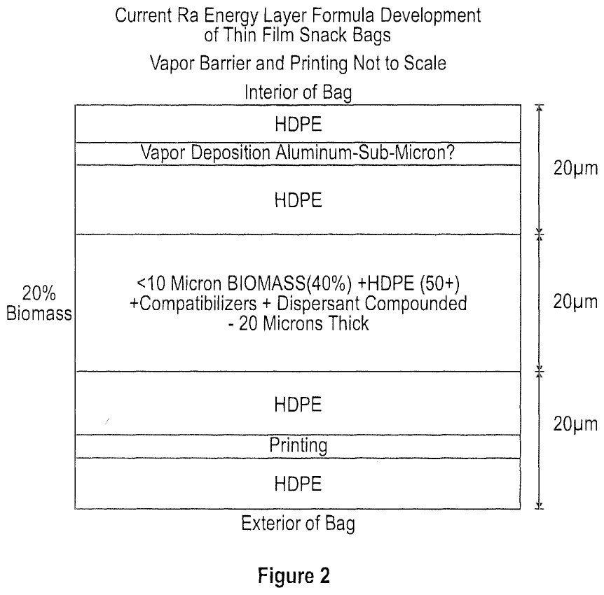

FIG. 2 illustrates a sectional view of the biomass-adhesive laminate; wherein all the layers of the laminate are shown.

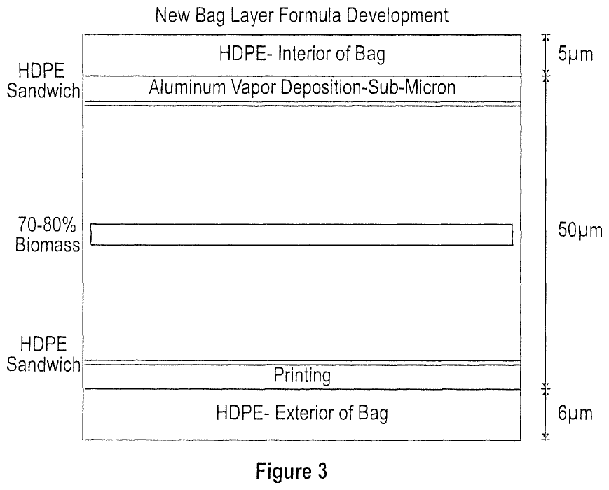

FIG. 3 illustrates a core laminate; wherein a molten hot-mix of biomass microfibres, adhesives and additives mixture is poured onto a roller assembly. The hot-mix is then allowed to cool down.

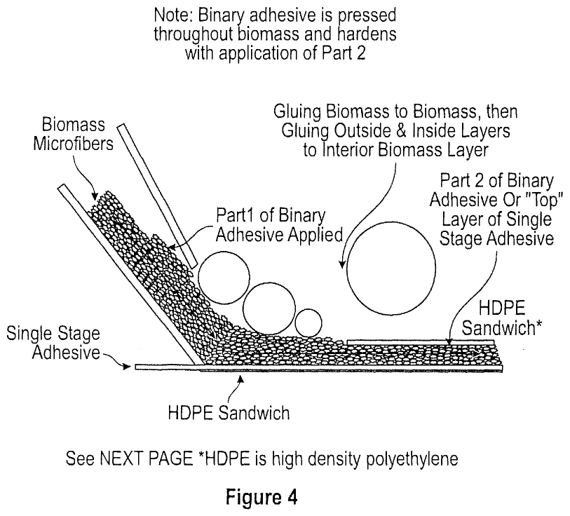

FIG. 4 illustrates a basic multi-laminate; wherein the plastic sheets are introduced in the assembly and are compressed to attach on each side of the biomass-adhesive mixture. Further, an optional adhesive layer may also be added between the plastic sheets and the biomass-adhesive mixture on both sides for gluing purposes.

### Examples

14 μm thick biomass-adhesive core laminate/adhesive laminate has been produced combining 10% Platamid 100 μm particle size adhesive with 70% −10 μmoat hull microfibers and 20% CaCO3 under pressure in a Carver lab press at 205f for 1.5 minutes (without benefit of pre-heating the mixture) to form an effective adhesion between the core adhesive-based laminate and 2 12-micron thick BOPET blown film sheets covered on one side with 0.5 μm vapor deposited aluminum on each side, glued to the core adhesive-based laminate, resulting in a strong bond between all laminates yielding a strong laminated composite. Other combinations of oat hulls, Platamid adhesive, CaCO3, with and without a micro thin spray of 3MSuper77 adhesive, and in one case 1% Fusabond all created strong bonds between laminates. All were pressed and heated as described above and cooled on the lab floor. Many combinations of the formula are possible in creating an optimized series of film products with high percentage of oat hulls.

The described embodiments are preferred and/or illustrated, but are not limiting. Various modifications are considered within the purview and scope of the appended claims.

What is claimed is:

1. A method of making a laminate; comprising:
mixing biomass-microfibers with an adhesive and optional additives wherein the mixture comprises at least 50% biomass-microfibers by weight;
heating the mixture above the melt temperature of the adhesive; and
disposing the heated mixture between plastic sheets while under compression to form a laminate having a desired thickness.

2. The method of claim 1, wherein the compression of adhesive with biomass and plastic sheet is performed using a roller system, a belt/roller system, opposing rollers, a belt system, or a combination thereof.

3. The method of claim 1, wherein plastic sheets are selected from BOPET (bi-oriented PET) polypropylene, high density polyethylene, PE, polylactic acid or combinations thereof.

4. The method of claim 1, wherein the mixture comprises at least 60% biomass-microfibers by weight.

5. The method of claim 1, wherein the mixture comprises at least 80% biomass-microfibers by weight.

6. The method of claim 1, wherein the mixture comprises at least 90% biomass-microfibers by weight.

7. The method of claim 1, wherein the biomass-microfibers have a maximum dimension less than 20 μm.

8. The method of claim 1, wherein the biomass-microfibers have a maximum dimension less than 15 μm.

9. The method of claim 1, wherein the biomass-microfibers have a maximum dimension less than 10 μm.

10. The method of claim 1, wherein the optional additives include calcium carbonate in an amount from 1% to 20% of the mixture by weight.

11. A laminate having a plurality of layers including a biomass layer that comprises a mixture of biomass-microfibers, at least one adhesive, and optionally one or more additives, wherein the total mass of resin, adhesive and optional additives in the biomass layer is less than the mass of the biomass-microfibers.

12. The laminate of claim 11, wherein the mixture comprises at least 60% biomass-microfibers by weight.

13. The laminate of claim 11, wherein the mixture comprises at least 80% biomass-microfibers by weight.

14. The laminate of claim 11, wherein the mixture comprises at least 90% biomass-microfibers by weight.

15. The laminate of claim 11, wherein the biomass-microfibers have a maximum dimension less than 20 μm.

16. The laminate of claim 11, wherein the biomass-microfibers have a maximum dimension less than 15 μm.

17. The laminate of claim 11, wherein the biomass-microfibers have a maximum dimension less than 10 μm.

18. The laminate of claim 11, wherein the optional additives include calcium carbonate in an amount from 1% to 20% of the mixture by weight.

19. A method of making a laminate, comprising:
(a) milling biomass in a mill to produce biomass-microfibers;
(b) mixing the milled biomass-microfibers with an adhesive;
(c) heating the mixture to a temperature above the melt temperature of the adhesive;
(d) blending the heated mixture with calcium carbonate to form a heated blend;
(e) disposing the heated blend between plastic sheets while under compression to form a laminate having a desired thickness; wherein the blend comprises at least 50% biomass-microfibers by weight and from 1% to 20% calcium carbonate by weight.
